(19) United States
(12) Patent Application Publication
(10) Pub. No.: US 2012/0295617 A1
(43) Pub. Date: Nov. 22, 2012

(54) SELECTIVELY EXTENDING A WAITING PERIOD BEFORE AN ORIGINATING USER EQUIPMENT FAILS A CALL BASED ON NETWORK INFORMATION OF ONE OR MORE TARGET USER EQUIPMENTS

(75) Inventors: Kirankumar ANCHAN, San Diego, CA (US); Hamsini Bhaskaran, San Diego, CA (US); Giridhar D. Mandyam, San Diego, CA (US); Mark A. Maggenti, San Diego, CA (US)

(73) Assignee: QUALCOMM Incorporated, San Diego, CA (US)

(21) Appl. No.: 13/110,763

(22) Filed: May 18, 2011

(51) Int. Cl. H04W 60/00

(52) U.S. Cl. 455/435.1

(57) ABSTRACT

In an embodiment, network information associated with a plurality of user equipments (UEs) is determined by an application server. For example, the network information can include information indicative of whether the respective UEs are connected to fast-response networks or slow-response networks. The application server receives a request from an originating UE to initiate a communication session to at least one target UE among the plurality of UEs. The application server selectively requests the originating UE to extend a wait timer based at least in part upon the determined network information for the at least one target UE, wherein expiration of the wait timer prompts the originating UE to fail the communication session. The originating UE receives the extension request from the application server and extends the wait timer such that call failure due to wait timer expiration is delayed and/or avoided.

### BACKGROUND OF THE INVENTION

1. Field of the Invention

Embodiments relate to selectively extending a waiting period before an originating user equipment (UE) fails a call based on network information of one or more target UEs.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (W-CDMA), CDMA2000 (such as CDMA2000 1xEV-DO standards, for example) or TD-SCDMA.

In W-CDMA wireless communication systems, user equipments (UEs) receive signals from fixed position Node Bs (also referred to as cell sites or cells) that support communication links or service within particular geographic regions adjacent to or surrounding the base stations. Node Bs provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the Node Bs generally interacts with UEs through an over the air interface and with the RAN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as W-CDMA, CDMA, FDMA, TDMA, GSM, etc. In a dispatch model, communication between endpoints (e.g., UEs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

### SUMMARY

In an embodiment, network information associated with a plurality of user equipments (UEs) is determined by an application server. For example, the network information can include information indicative of whether the respective UEs are connected to fast-response networks or slow-response networks. The application server receives a request from an originating UE to initiate a communication session to at least one target UE among the plurality of UEs. The application server selectively requests the originating UE to extend a wait timer based at least in part upon the determined network information for the at least one target UE, wherein expiration of the wait timer prompts the originating UE to fail the communication session. The originating UE receives the extension request from the application server and extends the wait timer such that call failure due to wait timer expiration is delayed and/or avoided.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports user equipments and radio access networks in accordance with at least one embodiment of the invention.

FIG. 2A illustrates the core network of FIG. 1 according to an embodiment of the present invention.

FIG. 2B illustrates an example of the wireless communications system of FIG. 1 in more detail.

FIG. 3 is an illustration of user equipment in accordance with at least one embodiment of the invention.

FIG. 4 illustrates a process of setting up a conventional delay-sensitive or latency-sensitive server-arbitrated communication session.

FIG. 5 illustrates a process of provisioning an application server with network information of a given user equipment in accordance with an embodiment of the invention.

FIG. 6 illustrates a process of setting up a delay-sensitive or latency-sensitive server-arbitrated communication session in accordance with an embodiment of the invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of non-transitory computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as user equipment (UE), may be mobile or stationary, and may communicate with one or more access points (APs), which may be referred to as Node Bs. A UE transmits and receives data packets through one or more of the Node Bs to a Radio Network Controller (RNC). The Node Bs and RNC are parts of a network called a radio access network (RAN). A radio access network can transport voice and data packets between multiple UEs.

The radio access network may be further connected to additional networks outside the radio access network, such core network including specific carrier related servers and devices and connectivity to other networks such as a corporate intranet, the Internet, public switched telephone network (PSTN), a Serving General Packet Radio Services (GPRS) Support Node (SGSN), a Gateway GPRS Support Node (GGSN), and may transport voice and data packets between each UE and such networks. A UE that has established an active traffic channel connection with one or more Node Bs may be referred to as an active UE, and can be referred to as being in a traffic state. A UE that is in the process of establishing an active traffic channel (TCH) connection with one or more Node Bs can be referred to as being in a connection setup state. A UE may be any data device that communicates through a wireless channel or through a wired channel. A UE may further be any of a number of types of devices including but not limited to PC card, compact flash device, external or internal modem, or wireless or wireline phone. The communication link through which the UE sends signals to the Node B(s) is called an uplink channel (e.g., a reverse traffic channel, a control channel, an access channel, etc.). The communication link through which Node B(s) send signals to a UE is called a downlink channel (e.g., a paging channel, a control channel, a broadcast channel, a forward traffic channel, etc.). As used herein the term traffic channel (TCH) can refer to either an uplink/reverse or downlink/forward traffic channel.

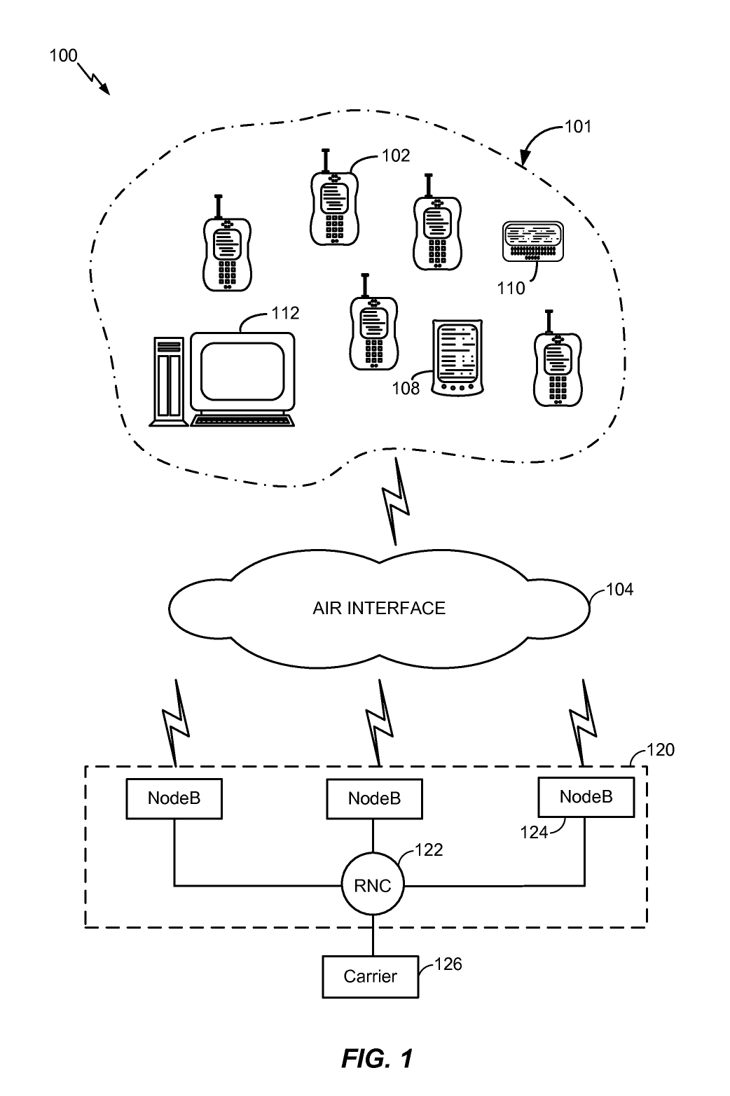

FIG. 1 illustrates a block diagram of one exemplary embodiment of a wireless communications system 100 in accordance with at least one embodiment of the invention. System 100 can contain UEs, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or core network 126) and the UEs 102, 108, 110, 112. As shown here, the UE can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the term “UE” in other communication protocols (i.e., other than W-CDMA) may be referred to interchangeably as an “access terminal”, “AT”, “wireless device”, “client device”, “mobile terminal”, “mobile station” and variations thereof.

Referring back to FIG. 1, the components of the wireless communications system 100 and interrelation of the elements of the exemplary embodiments of the invention are not limited to the configuration illustrated. System 100 is merely exemplary and can include any system that allows remote UEs, such as wireless client computing devices 102, 108, 110, 112 to communicate over-the-air between and among each other and/or between and among components connected via the air interface 104 and RAN 120, including, without limitation, core network 126, the Internet, PSTN, SGSN, GGSN and/or other remote servers.

The RAN 120 controls messages (typically sent as data packets) sent to a RNC 122. The RNC 122 is responsible for signaling, establishing, and tearing down bearer channels (i.e., data channels) between a Serving General Packet Radio Services (GPRS) Support Node (SGSN) and the UEs 102/108/110/112. If link layer encryption is enabled, the RNC 122 also encrypts the content before forwarding it over the air interface 104. The function of the RNC 122 is well-known in the art and will not be discussed further for the sake of brevity. The core network 126 may communicate with the RNC 122 by a network, the Internet and/or a public switched telephone network (PSTN). Alternatively, the RNC 122 may connect directly to the Internet or external network. Typically, the network or Internet connection between the core network 126 and the RNC 122 transfers data, and the PSTN transfers voice information. The RNC 122 can be connected to multiple Node Bs 124. In a similar manner to the core network 126, the RNC 122 is typically connected to the Node Bs 124 by a network, the Internet and/or PSTN for data transfer and/or voice information. The Node Bs 124 can broadcast data messages wirelessly to the UEs, such as cellular telephone 102. The Node Bs 124, RNC 122 and other components may form the RAN 120, as is known in the art. However, alternate configurations may also be used and the invention is not limited to the configuration illustrated. For example, in another embodiment the functionality of the RNC 122 and one or more of the Node Bs 124 may be collapsed into a single “hybrid” module having the functionality of both the RNC 122 and the Node B(s) 124.

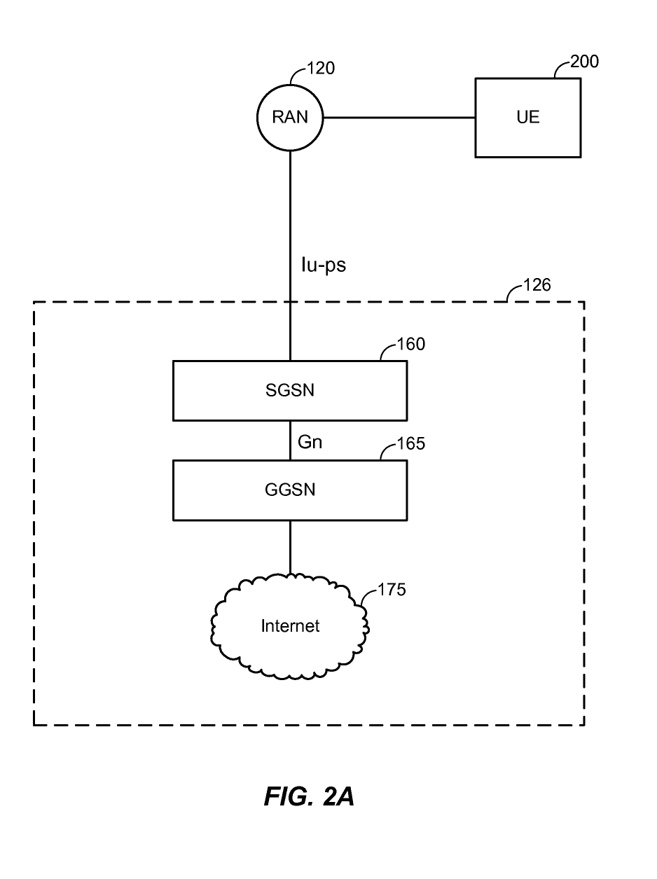

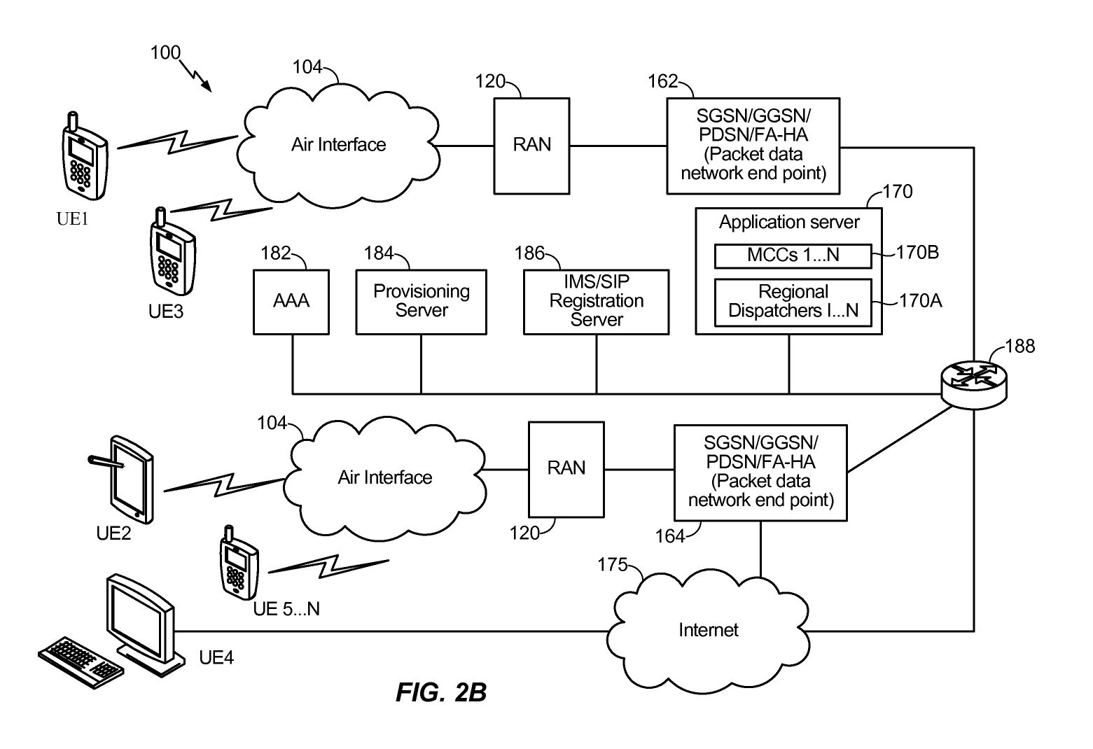

FIG. 2A illustrates the core network 126 according to an embodiment of the present invention. In particular, FIG. 2A illustrates components of a General Packet Radio Services (GPRS) core network implemented within a W-CDMA system. In the embodiment of FIG. 2A, the core network 126 includes a Serving GPRS Support Node (SGSN) 160, a Gateway GPRS Support Node (GGSN) 165 and an Internet 175. However, it is appreciated that portions of the Internet 175 and/or other components may be located outside the core network in alternative embodiments.

Generally, GPRS is a protocol used by Global System for Mobile communications (GSM) phones for transmitting Internet Protocol (IP) packets. The GPRS Core Network (e.g., the GGSN 165 and one or more SGSNs 160) is the centralized part of the GPRS system and also provides support for W-CDMA based 3G networks. The GPRS core network is an integrated part of the GSM core network, provides mobility management, session management and transport for IP packet services in GSM and W-CDMA networks.

The GPRS Tunneling Protocol (GTP) is the defining IP protocol of the GPRS core network. The GTP is the protocol which allows end users (e.g., access terminals) of a GSM or W-CDMA network to move from place to place while continuing to connect to the internet as if from one location at the GGSN 165. This is achieved transferring the subscriber's data from the subscriber's current SGSN 160 to the GGSN 165, which is handling the subscriber's session.

Three forms of GTP are used by the GPRS core network; namely, (i) GTP-U, (ii) GTP-C and (iii) GTP′ (GTP Prime). GTP-U is used for transfer of user data in separated tunnels for each packet data protocol (PDP) context. GTP-C is used for control signaling (e.g., setup and deletion of PDP contexts, verification of GSN reach-ability, updates or modifications such as when a subscriber moves from one SGSN to another, etc.). GTP′ is used for transfer of charging data from GSNs to a charging function.

Referring to FIG. 2A, the GGSN 165 acts as an interface between the GPRS backbone network (not shown) and the external packet data network 175. The GGSN 165 extracts the packet data with associated packet data protocol (PDP) format (e.g., IP or PPP) from the GPRS packets coming from the SGSN 160, and sends the packets out on a corresponding packet data network. In the other direction, the incoming data packets are directed by the GGSN 165 to the SGSN 160 which manages and controls the Radio Access Bearer (RAB) of the destination UE served by the RAN 120. Thereby, the GGSN 165 stores the current SGSN address of the target UE and his/her profile in its location register (e.g., within a PDP context). The GGSN is responsible for IP address assignment and is the default router for the connected UE. The GGSN also performs authentication and charging functions.

The SGSN 160 is representative of one of many SGSNs within the core network 126, in an example. Each SGSN is responsible for the delivery of data packets from and to the UEs within an associated geographical service area. The tasks of the SGSN 160 includes packet routing and transfer, mobility management (e.g., attach/detach and location management), logical link management, and authentication and charging functions. The location register of the SGSN stores location information (e.g., current cell, current VLR) and user profiles (e.g., IMSI, PDP address(es) used in the packet data network) of all GPRS users registered with the SGSN 160, for example, within one or more PDP contexts for each user or UE. Thus, SGSNs are responsible for (i) de-tunneling downlink GTP packets from the GGSN 165, (ii) uplink tunnel IP packets toward the GGSN 165, (iii) carrying out mobility management as UEs move between SGSN service areas and (iv) billing mobile subscribers. As will be appreciated by one of ordinary skill in the art, aside from (i)-(iv), SGSNs configured for GSM/EDGE networks have slightly different functionality as compared to SGSNs configured for W-CDMA networks.

The RAN 120 (e.g., or UTRAN, in Universal Mobile Telecommunications System (UMTS) system architecture) communicates with the SGSN 160 via a Iu interface, with a transmission protocol such as Frame Relay or IP. The SGSN 160 communicates with the GGSN 165 via a Gn interface, which is an IP-based interface between SGSN 160 and other SGSNs (not shown) and internal GGSNs, and uses the GTP protocol defined above (e.g., GTP-U, GTP-C, GTP', etc.). While not shown in FIG. 2A, the Gn interface is also used by the Domain Name System (DNS). The GGSN 165 is connected to a Public Data Network (PDN) (not shown), and in turn to the Internet 175, via a Gi interface with IP protocols either directly or through a Wireless Application Protocol (WAP) gateway.

The PDP context is a data structure present on both the SGSN 160 and the GGSN 165 which contains a particular UE's communication session information when the UE has an active GPRS session. When a UE wishes to initiate a GPRS communication session, the UE must first attach to the SGSN 160 and then activate a PDP context with the GGSN 165. This allocates a PDP context data structure in the SGSN 160 that the subscriber is currently visiting and the GGSN 165 serving the UE's access point.

FIG. 2B illustrates an example of the wireless communications system 100 of FIG. 1 in more detail. In particular, referring to FIG. 2B, UEs 1 . . . N are shown as connecting to the RAN 120 at locations serviced by different packet data network end-points. The illustration of FIG. 2B is specific to W-CDMA systems and terminology, although it will be appreciated how FIG. 2B could be modified to confirm with a 1× EV-DO system. Accordingly, UEs 1 and 3 connect to the RAN 120 at a portion served by a first packet data network end-point 162 (e.g., which may correspond to SGSN, GGSN, PDSN, a home agent (HA), a foreign agent (FA), etc.). The first packet data network end-point 162 in turn connects, via the routing unit 188, to the Internet 175 and/or to one or more of an authentication, authorization and accounting (AAA) server 182, a provisioning server 184, an Internet Protocol (IP) Multimedia Subsystem (IMS)/Session Initiation Protocol (SIP) Registration Server 186 and/or the application server 170. UEs 2 and 5 . . . N connect to the RAN 120 at a portion served by a second packet data network end-point 164 (e.g., which may correspond to SGSN, GGSN, PDSN, FA, HA, etc.). Similar to the first packet data network end-point 162, the second packet data network end-point 164 in turn connects, via the routing unit 188, to the Internet 175 and/or to one or more of the AAA server 182, a provisioning server 184, an IMS/SIP Registration Server 186 and/or the application server 170. UE 4 connects directly to the Internet 175, and through the Internet 175 can then connect to any of the system components described above.

Referring to FIG. 2B, UEs 1, 3 and 5 . . . N are illustrated as wireless cell-phones, UE 2 is illustrated as a wireless tablet-PC and UE 4 is illustrated as a wired desktop station. However, in other embodiments, it will be appreciated that the wireless communication system 100 can connect to any type of UE, and the examples illustrated in FIG. 2B are not intended to limit the types of UEs that may be implemented within the system. Also, while the AAA 182, the provisioning server 184, the IMS/SIP registration server 186 and the application server 170 are each illustrated as structurally separate servers, one or more of these servers may be consolidated in at least one embodiment of the invention.

Further, referring to FIG. 2B, the application server 170 is illustrated as including a plurality of media control complexes (MCCs) 1 . . . N 170B, and a plurality of regional dispatchers 1 . . . N 170A. Collectively, the regional dispatchers 170A and MCCs 170B are included within the application server 170, which in at least one embodiment can correspond to a distributed network of servers that collectively functions to arbitrate communication sessions (e.g., half-duplex group communication sessions via IP unicasting and/or IP multicasting protocols) within the wireless communication system 100. For example, because the communication sessions arbitrated by the application server 170 can theoretically take place between UEs located anywhere within the system 100, multiple regional dispatchers 170A and MCCs are distributed to reduce latency for the arbitrated communication sessions (e.g., so that a MCC in North America is not relaying media back-and-forth between session participants located in China). Thus, when reference is made to the application server 170, it will be appreciated that the associated functionality can be enforced by one or more of the regional dispatchers 170A and/or one or more of the MCCs 170B. The regional dispatchers 170A are generally responsible for any functionality related to establishing a communication session (e.g., handling signaling messages between the UEs, scheduling and/or sending announce messages, etc.), whereas the MCCs 170B are responsible for hosting the communication session for the duration of the call instance, including conducting an in-call signaling and an actual exchange of media during an arbitrated communication session.

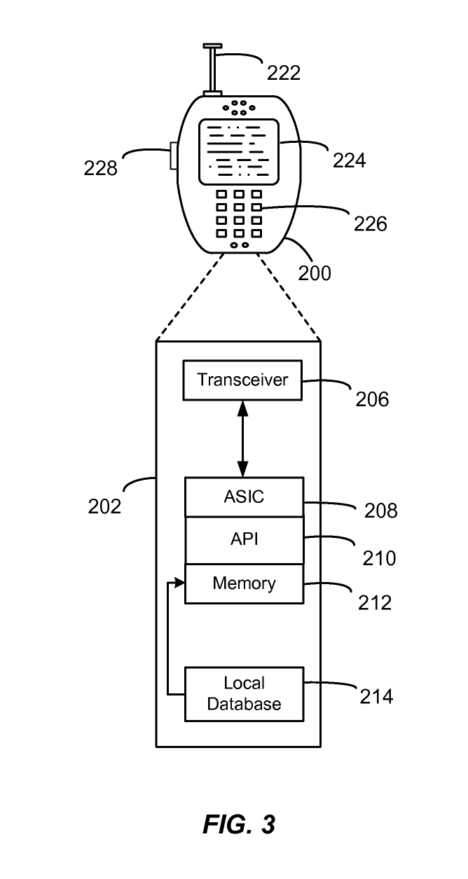

Referring to FIG. 3, a UE 200, (here a wireless device), such as a cellular telephone, has a platform 202 that can receive and execute software applications, data and/or commands transmitted from the RAN 120 that may ultimately come from the core network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include a UE including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the UE 200 in FIG. 3 are to be considered merely illustrative and the invention is not limited to the illustrated features or arrangement.

The wireless communication between the UE 102 or 200 and the RAN 120 can be based on different technologies, such as code division multiple access (CDMA), W-CDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. For example, in W-CDMA, the data communication is typically between the client device 102, Node B(s) 124, and the RNC 122. The RNC 122 can be connected to multiple data networks such as the core network 126, PSTN, the Internet, a virtual private network, a SGSN, a GGSN and the like, thus allowing the UE 102 or 200 access to a broader communication network. As discussed in the foregoing and known in the art, voice transmission and/or data can be transmitted to the UEs from the RAN using a variety of networks and configurations. Accordingly, the illustrations provided herein are not intended to limit the embodiments of the invention and are merely to aid in the description of aspects of embodiments of the invention.

Below, embodiments of the invention are generally described in accordance with W-CDMA protocols and associated terminology (e.g., such as UE instead of mobile station (MS), mobile unit (MU), access terminal (AT), etc., RNC, contrasted with BSC in EV-DO, or Node B, contrasted with BS or MPT/BS in EV-DO, etc.). However, it will be readily appreciated by one of ordinary skill in the art how the embodiments of the invention can be applied in conjunction with wireless communication protocols other than W-CDMA.

In a conventional server-arbitrated communication session (e.g., via half-duplex protocols, full-duplex protocols, VoIP, a group session over IP unicast, a group session over IP multicast, a push-to-talk (PTT) session, a push-to-transfer (PTX) session, etc.), a session or call originator sends a request to initiate a communication session to the application server 170, which then forwards a call announcement message to the RAN 120 for transmission to one or more targets of the call.

User Equipments (UEs), in a Universal Mobile Telecommunications Service (UMTS) Terrestrial Radio Access Network (UTRAN) (e.g., the RAN 120) may be in either an idle mode or a radio resource control (RRC) connected mode.

Based on UE mobility and activity while in a RRC connected mode, the RAN 120 may direct UEs to transition between a number of RRC sub-states; namely, CELL_PCH, URA_PCH, CELL_FACH, and CELL_DCH states, which may be characterized as follows:
In the CELL_DCH state, a dedicated physical channel is allocated to the UE in uplink and downlink, the UE is known on a cell level according to its current active set, and the UE has been assigned dedicated transport channels, downlink and uplink (TDD) shared transport channels, and a combination of these transport channels can be used by the UE.
In the CELL_FACH state, no dedicated physical channel is allocated to the UE, the UE continuously monitors a forward access channel (FACH), the UE is assigned a default common or shared transport channel in the uplink (e.g., a random access channel (RACH), which is a contention-based channel with a power ramp-up procedure to acquire the channel and to adjust transmit power) that the UE can transmit upon according to the access procedure for that transport channel, the position of the UE is known by RAN 120 on a cell level according to the cell where the UE last made a previous cell update, and, in TDD mode, one or several USCH or DSCH transport channels may have been established.
In the CELL_PCH state, no dedicated physical channel is allocated to the UE, the UE selects a PCH with the algorithm, and uses DRX for monitoring the selected PCH via an associated PICH, no uplink activity is possible and the position of the UE is known by the RAN 120 on cell level according to the cell where the UE last made a cell update in CELL_FACH state.
In the URA_PCH state, no dedicated channel is allocated to the UE, the UE selects a PCH with the algorithm, and uses DRX for monitoring the selected PCH via an associated PICH, no uplink activity is possible, and the location of the UE is known to the RAN 120 at a Registration area level according to the UTRAN registration area (URA) assigned to the UE during the last URA update in CELL_FACH state.

Accordingly, URA_PCH State (or CELL_PCH State) corresponds to a dormant state where the UE periodically wakes up to check a paging indicator channel (PICH) and, if needed, the associated downlink paging channel (PCH), and it may enter CELL_FACH state to send a Cell Update message for the following event: cell reselection, periodical cell update, uplink data transmission, paging response, re-entered service area. In CELL_FACH State, the UE may send messages on the random access channel (RACH), and may monitor a forward access channel (FACH). The FACH carries downlink communication from the RAN 120, and is mapped to a secondary common control physical channel (S-CCPCH). From CELL_FACH State, the UE may enter CELL_DCH state after a traffic channel (TCH) has been obtained based on messaging in CELL_FACH state. A table showing conventional dedicated traffic channel (DTCH) to transport channel mappings in radio resource control (RRC) connected mode, is in Table 1 as follows:

TABLE 1
DTCH to Transport Channel mappings in RRC connected mode

| | RACH | FACH | DCH | E-DCH | HS-DSCH |
|---|---|---|---|---|---|
| CELL_DCH | No | No | Yes | Yes | Yes |
| CELL_FACH | Yes | Yes | No | Yes (rel. 8) | Yes (rel. 7) |
| CELL_PCH | No | No | No | No | Yes (rel. 7) |
| URA_PCH | No | No | No | No | No |

wherein the notations (rel. 8) and (rel. 7) indicate the associated 3GPP release where the indicated channel was introduced for monitoring or access.

Communication sessions arbitrated by the application server 170, in at least one embodiment, may be associated with delay-sensitive or high-priority applications and/or services. For example, the application server 170 may correspond to a PTT server in at least one embodiment, and it will be appreciated that an important criterion in PTT sessions is fast session set-up as well as maintaining a given level of Quality of Service (QoS) throughout the session.

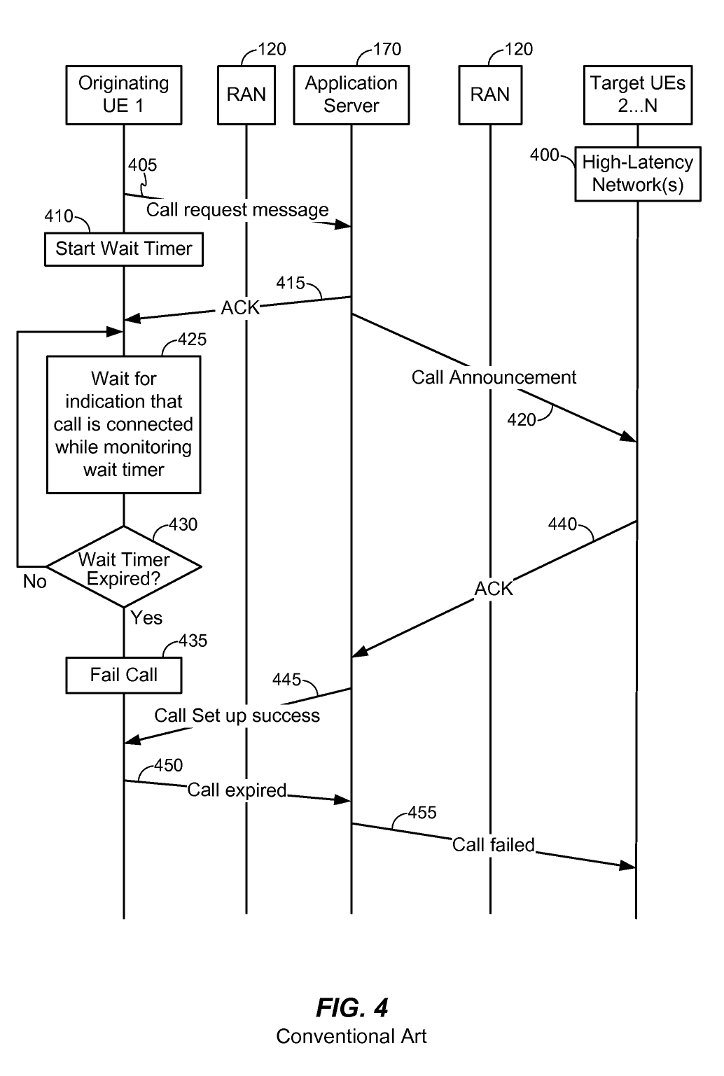

FIG. 4 illustrates a process of setting up a conventional delay-sensitive or latency-sensitive server-arbitrated communication session (e.g., PTT, VoIP, etc.). In particular, FIG. 4 illustrates an example whereby the delay-sensitive communication session is set-up between an originating UE 1 and one or more target UEs 2 . . . N, where N>2. In FIG. 4, it may be assumed that the target UEs 2 . . . N are connected to high-latency network(s) associated with slow responses to call announce messages, 400. For example, target UEs 2 . . . N may be connected to roaming networks, a section of a home network that does not support Quality of Service (QoS), a home or roaming network with poor backhaul performance or internetwork communication delays, poor air interface performance (e.g., a satellite-based network with high propagation latency), a 2G or 2.5G network and so on. Thus, the high-latency nature of the network(s) of target UEs 2 . . . N may be the result of any network performance criterion that can cause responses to call announce messages from the target UEs 2 . . . N to take a relatively long time.

While target UEs 2 . . . N remain connected to the high-latency network(s) in 400, an originating UE 1 sends a call request message configured to initiate a communication session to the target UEs 2 . . . N to the RAN 120, which forwards the call request message to the application server 170, 405. For example, the call request message can be transmitted from the originating UE 1 in response to a user of UE 1 pressing a PTT button.

After transmitting the call request message, the originating UE 1 starts a wait timer having a predetermined expiration period, 410. The predetermined expiration period corresponds to an amount of time (e.g., 3 seconds, 5 seconds, etc.) that a multimedia application at the originating UE 1 is willing to wait for an indication, from the application server 170, that one or more of target UEs 2 . . . N has accepted the call. Thus, if the wait timer expires without the originating UE 1 receiving any indication that the call has been accepted by one or more of target UEs 2 . . . N, the multimedia application at the originating UE 1 will fail the call.

Referring to FIG. 4, the application server 170 receives the call request message, and acknowledges receipt of the call request message to the originating UE 1, 415. The application server 170 also identifies and locates the target UEs 2 . . . N for the communication session, and then transmits an announce message for the communication session to target UEs 2 . . . N, 420. At this point, the application server 170 does not conventionally have special knowledge regarding the networks to which the target UEs 2 . . . N are connected (e.g., whether the serving network(s) of target UEs 2 . . . N are 2G, 3G, satellite-based or terrestrial-based, roaming, home, etc.). In particular, the application server 170 is not aware that the target UEs 2 . . . N are connected to high-latency network(s) and that responses to the announce message of 420 are likely to take a relatively long time. After transmitting the announce message in 420, the application server 170 waits to receive acknowledgments to the announce message of 420 from the target UEs 2 . . . N.

Turning back to the originating UE 1, after starting the wait timer in 410, the originating UE 1 monitors for any indication that the call has been accepted or connected, 425. The originating UE 1 also monitors the wait timer to determine whether the wait timer has expired, 430. If the originating UE 1 determines that the wait timer has not yet expired and the call has not yet been connected in 430, the process returns to 425 and the originating UE 1 continues to monitor for any indication that the call has been accepted or connected. Otherwise, if the originating UE 1 determines that the wait timer has expired and the call has not yet been accepted in 430, the originating UE fails the call in 435. By failing the call, the multimedia application on the originating UE 1 will not engage in the failed call even in the event of a subsequent indication from the application server 170 that one or more of target UEs 2 . . . N has accepted or joined the call.

Referring to FIG. 4, at some point after the application server 170 transmits the announce message to target UEs 2 . . . N in 420 within their respective high-latency network(s), assume that one or more of target UEs 2 . . . N answers the announce message and indicates a desire to join the announced communication session (e.g., via an announce ACK (accept) message), 440. Upon receiving an affirmative announce acknowledgment from a first responder among the target UEs 2 . . . N, the application server 170 determines that the call can be connected and thereby notifies the originating UE 1 that the communication session has been accepted or connected, 445. For example, the notification of 445 can correspond to a status (success) message as shown in FIG. 4.

However, despite the target UEs 2 . . . N accepting the announced communication session, the originating UE 1 already failed the call at 435 by the time the status message was received in 445. Accordingly, the originating UE 1 cannot accept the call at this point and thereby sends a call rejection message (e.g., ACK (reject) message) to the application server 170 in 450, at which point the application server 170 notifies the target UEs 2 . . . N of the call failure, 455.

As will be appreciated, FIG. 4 illustrates an example whereby late responses from target UEs in high-latency or slow-response networks result in call failure. The prevalence of this type of call failure can be reduced by arbitrarily increasing the duration of the wait timer during call set-up for all calls. However, target UEs being located in high-latency or slow-response networks is only one of many reasons why calls fail. Other causations of failure for call attempts include target UE unavailability and/or an unwillingness of target UEs to accept an announced call. In these cases, increasing the wait timer will not increase the call success rate and will actually degrade the user experience at the originating UEs in the sense that users of originating UEs will be forced to wait for a longer period of time before learning when calls have failed.

Embodiments are directed to provisioning the application server 170 with network information of UEs subscribing to a given service, such as VoIP, PTT, PTX, etc. Later, when one or more of the UEs is associated with a call set-up procedure with the application server 170, the application server 170 can use the network information for the one or more UEs to selectively extend an expiration period of the wait timer at an originating UE in order to gain more call-time for call set-up before the call attempt results in failure.

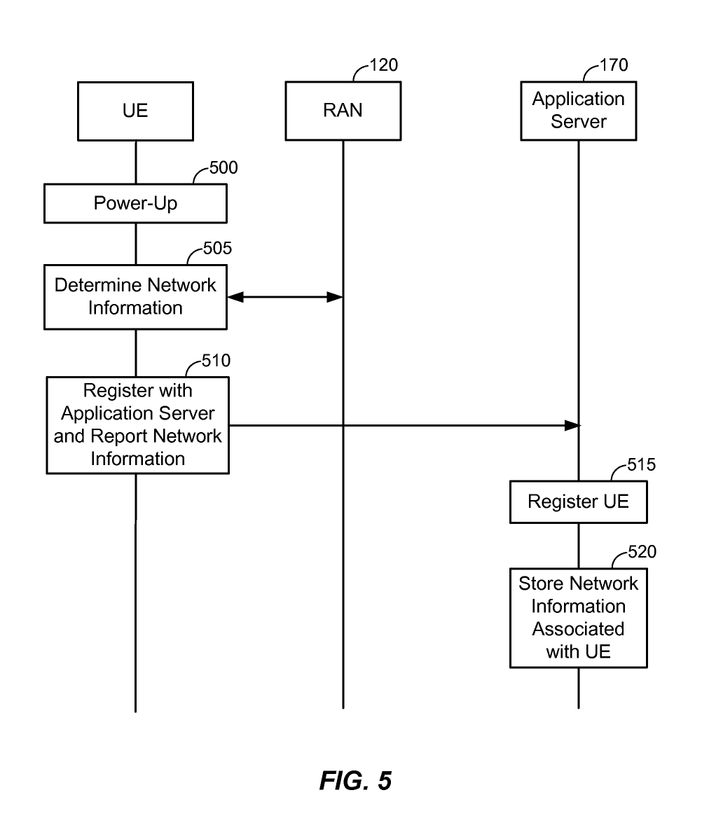

FIG. 5 illustrates a process of provisioning the application server 170 with network information of a given UE in accordance with an embodiment of the invention. Referring to FIG. 5, the given UE powers-up at 500 and then determines network information, 505.

Referring to 505 of FIG. 5, in an example, the network information determination operation of 505 can include a camping procedure by which the UEs monitor for available networks and then camp on cell or sector within a particular Public Land Mobile Network (PLMN). In this case, the network information may correspond to a PLMN identifier (ID) and/or a sector or cell identifier (ID) of the PLMN to which the given UE is camped. In another example, the network information determination operation of 505 can include a network-type identifier (e.g., IEEE 802.11a/b/g/n or WiFi, a FEMTO cell, 2G, 2.5G, 3G, 4G, EV-DO, 1×, etc.). In another example, the network information determination operation of 505 can include a status of a serving network as a home network or a roaming network. In this case, the PLMN ID and/or sector or cell ID can be used to infer the roaming or home status of the network, in an example. In another example, the network information determination operation of 505 can include a determination as to whether QoS is supported in the serving network of the given UE. Generally, the network information determined in 505 can correspond to any type of information that can characterize a response time of the serving network of the given UE in an attempt to predict or infer how quickly the given UE is likely to respond to a call announcement message. For example, the network information can correspond to a status of the PLMN upon which the given UE is camped as a home network or a roaming network, with home networks generally expected to have faster response times as compared to roaming networks (e.g., due to tunneling, etc.).

After determining the network information in 505, the given UE registers with the application server 170 for the given service and also reports the determined network information, 510. The application server 170 registers the given UE for the given service, 515, and also stores the determined network information that was reported by the given UE, 520.

While not shown explicitly in FIG. 5, the determined network information of the given UE can be leveraged by the application server 170 to predict how quickly the given UE is likely to respond to announce messages sent to the given UE. In an example, the determined network information can correspond to the PLMN ID (or PLMN ID and sector ID combination) that identifies the PLMN (or PLMN and sector) for the given UE. In this case, the application server 170 can maintain a serving area ID table that maps a list of serving area IDs (e.g., PLMNs IDs and/or sector IDs) to network performance characteristics (e.g., an expected latency value, a QoS support indication, roaming or home network, etc.). Accordingly, by comparing the reported PLMN ID and/or sector ID of the given UE to the serving area ID table, the application server 170 can identify matching PLMN ID and/or sector ID entries and then retrieve the corresponding network performance characteristics. In an example, if the reported PLMN ID and/or sector ID of the given UE does not match any entries in the serving area ID table, the application server 170 may associate default network performance characteristics with the given UE and may later update the serving area ID table to reflect an indication of the actual network performance achieved by the given UE in the respective PLMN and/or a particular sector within the respective PLMN.

In an alternative example, as noted above, the given UE can explicitly report the network performance characteristics in the report or registration of 510. For example, the given UE can collect the information regarding the network performance characteristics from its serving network in 505 (e.g., whether QoS is supported, historical backhaul performance, an air interface type or performance metric such as distance to base station, whether the UE is served by a satellite or terrestrial base station, etc.), and can then report the network performance characteristics to the application server 170 in 510 instead of simply reporting a serving area identifier such as the PLMN ID and/or sector ID. In this case, the application server 170 could then update the serving area ID table to reflect the network performance characteristics that were reported by the given UE in the event that no entries for the given UE's PLMN and/or sector were present in the serving area ID table.

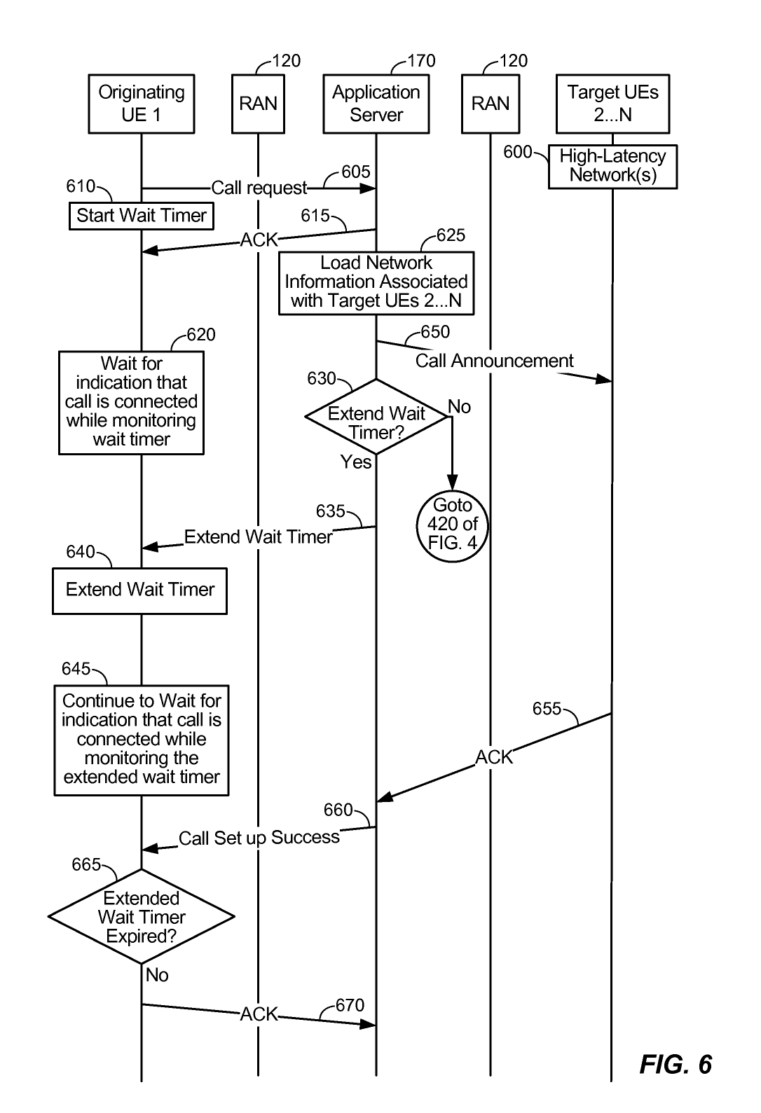

FIG. 6 illustrates a process of setting up a delay-sensitive or latency-sensitive server-arbitrated communication session in accordance with an embodiment of the invention. In particular, FIG. 6 illustrates an example whereby the delay-sensitive communication session is set-up between an originating UE 1 and one or more of target UEs 2 . . . N, where N>2. Referring to FIG. 6, assume that at least one of target UEs 2 . . . N is connected to a high-latency network associated with slow responses to call announce messages, 600. For example, the at least one target UE among target UEs 2 . . . N may be connected to a roaming network, a section of a home network that does not support QoS, a home or roaming network with poor backhaul performance or internetwork communication delays, a network with poor air interface performance (e.g., a satellite-based network with high propagation latency or a terrestrial-based network where the at least one target UE is relatively far away from the serving base station), a 2G or 2.5G network and so on. Thus, when a network of target UEs 2 . . . N is referred to as ‘high-latency’, it will be appreciated that this may be the result of any performance criterion that can cause responses to call announce messages from the target UEs 2 . . . N to take a relatively long time.

While at least one of target UEs 2 . . . N remain connected to the high-latency network(s) in 600, an originating UE 1 sends a call request message configured to initiate a communication session to the target UEs 2 . . . N to the RAN 120, which forwards the call request message to the application server 170, 605. For example, the call request message can be transmitted from the originating UE 1 in response to a user of UE 1 pressing a PTT button.

After transmitting the call request message, the originating UE 1 starts a wait timer having a first expiration period, 610. The first expiration period corresponds to an amount of time that a multimedia application at the originating UE 1 is willing to wait for an indication, from the application server 170, that one or more of target UEs 2 . . . N has accepted the call. Thus, if the wait timer expires without the originating UE 1 receiving any indication that the call has been accepted, the multimedia application at the originating UE 1 will fail the call. In the embodiment of FIG. 6, the duration of the first expiration period may correspond to the duration of the predetermined expiration period of the wait timer of FIG. 4 as discussed above, in an example.

Referring to FIG. 6, the application server 170 receives the call request message, and acknowledges receipt of the call request message to the originating UE 1, 615. After starting the wait timer in 610, the originating UE 1 monitors for any indication that the call has been accepted or connected, 620. Also in 620, the originating UE 1 monitors the wait timer to determine whether the first expiration period of the wait timer has expired.

In the embodiment of FIG. 6, assume that each of target UEs 2 . . . N have already performed the process of FIG. 5, such that the application server 170 is aware of the network information for each of target UEs 2 . . . N. Accordingly, upon receipt of the call request message from the originating UE 1 in 605, the application server 170 identifies and locates the target UEs 2 . . . N for the communication session, and also loads the respective network information of the target UEs 2 . . . N, 625. Based on the network information for the target UEs, the application server 170 determines whether to extend the wait timer at the originating UE 1, 630.

Referring to 630 of FIG. 6, for example, assume that N=2 such that the call being set-up is between the originating UE 1 and a single target UE 2. In this case, the network information for target UE 2 can be used to determine whether to extend the wait timer at the originating UE 1. For example, the application server 170 may determine to extend the wait timer at the originating UE 1 if the network information for target UE 2 indicates that target UE 2 is being served by a network via a satellite base station, a terrestrial base station that is far away from the target UE 2, a network that lacks QoS support, a roaming network, a home network section with poor backhaul performance and so on. Further, the network information can further be used to establish a degree to which the wait timer is to be extended. Thus, if the network information indicates that the target UE 2 is served by a particularly poor-performing network in terms of latency, the wait timer can be extended to a greater degree as compared to a network with an intermediate-performance level in terms of latency.

Referring to 630 of FIG. 6, in another example, assume that N>2 such that the call being set-up is between the originating UE and a plurality of target UEs. In this case, it will be appreciated that some of the target UEs 2 . . . N may be located in low-latency or fast response networks whereas others of the target UEs 2 . . . N may be located in high-latency or slow-response networks. It will be further appreciated that if a high number of the target UEs 2 . . . N are in fast-response networks, it is likely that the call will be set-up successfully before the expiration of the first expiration period of the wait timer even though some of the target UEs 2 . . . N may be late to respond due to their connection to slow-response networks. Accordingly, when a call is to be announced to multiple target UEs, the application server 170 can apply a weighting function to the network information for the multiple target UEs. For example, an expected latency value for the multiple target UEs can be averaged to derive an average expected latency value that is used in 630 to determine whether to extend the wait timer at the originating UE 1.

Returning to 630 of FIG. 6, if the application server 170 determines not to extend the wait timer in 630 (e.g., based on one or more of the target UEs 2 . . . N being in fast response or low-latency networks, etc.), the process advances to 420 of FIG. 4 whereby the application server 170 announces the communication session to the target UEs 2 . . . N without extending the wait timer at the originating UE 1. Alternatively, if the application server 170 determines to extend the wait timer in 630 (e.g., based on one or more of the target UEs 2 . . . N being in slow response or high-latency networks, etc.), the application server 170 requests that the originating UE 1 extend the wait timer, 635. The originating UE 1 receives the request from the application server 170 and then extends the wait timer from the first expiration period to a second expiration period, 640. For example, the extension of 640 may be to add a given amount of time to the first expiration period to achieve the second expiration period (e.g., +3 seconds, +800 ms, etc.). In another example, the extension of 640 may be to multiply the first expiration period by a given multiplication factor to achieve the second expiration period (e.g., ×2, ×3, etc.). In another example, the extension of 640 may be to replace the first expiration period with a new expiration period explicitly conveyed within the request of 635.

After extending the wait timer in 640, the originating UE 1 continues to monitor for any indication that the call has been accepted or connected, while also monitoring the extended wait timer to determine whether the second expiration period of the extended wait timer has expired, 645.

Turning back to the application server 170, along with transmitting the request to extend the wait timer to the originating UE 1 in 635, the application server 170 sends an announce message for announcing the communication session to target UEs 2 . . . N, 650. At some point after the application server 170 transmits the announce message to target UEs 2 . . . N in 655 within their respective network(s), assume that one or more of target UEs 2 . . . N answers the announce message and indicates a desire to join the announced communication session (e.g., via an acknowlede message), 655. Upon receiving an affirmative announce acknowledgment from a first responder among the target UEs 2 . . . N, the application server 170 determines that the call can be connected and thereby notifies the originating UE 1 that the communication session has been accepted or connected, 660. For example, the notification of 660 can correspond to a status (success) message as shown in FIG. 6.

The originating UE 1 receives the status (success) message and determines whether the extended wait timer has already expired such that the call has failed and cannot be joined, 665. In the embodiment of FIG. 6, due to the extension of the wait timer from the first expiration to the second expiration period, assume that the originating UE 1 determines that the extended wait timer has not yet expired when the status (success) message is received in 660. Accordingly, the originating UE 1 determines that the extended wait timer is not expired in 665 and thereby affirmatively acknowledges the call in 670, after which the communication session can begin.

While references in the above-described embodiments of the invention have generally used the terms ‘call’ and ‘session’ interchangeably, it will be appreciated that any call and/or session is intended to be interpreted as inclusive of actual calls between different parties, or alternatively to data transport sessions that technically may not be considered as ‘calls’. Also, while above-embodiments have generally described with respect to PTT sessions, other embodiments can be directed to any type of communication session, such as a push-to-transfer (PTX) session, an emergency VoIP call, etc.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary non-transitory storage medium is coupled to the processor such that the processor can read information from, and write information to, the non-transitory storage medium. In the alternative, the non-transitory storage medium may be integral to the processor. The processor and the non-transitory storage medium may reside in an ASIC. The ASIC may reside in a user terminal (e.g., access terminal). In the alternative, the processor and the non-transitory storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a non-transitory computer-readable medium. Non-transitory computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other non-transitory medium that can be used to carry or store desired program code in the form of instructions or data structures and that can be accessed by a computer. Also, any connection is properly termed a non-transitory computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of establishing a communication session at an application server, comprising:
determining network information associated with a plurality of user equipments (UEs);
receiving, from an originating UE, a request to initiate a communication session to at least one target UE among the plurality of UEs; and
selectively requesting the originating UE to extend a wait timer based at least in part upon the determined network information for the at least one target UE,
wherein expiration of the wait timer prompts the originating UE to fail the communication session.

2. The method of claim 1, wherein the determining step includes:
receiving one or more registration messages from the plurality of UEs that are indicative of network performance characteristics of current networks to which the plurality of UEs are connected.

3. The method of claim 1, wherein the determining step includes:
receiving one or more registration messages from the plurality of UEs that are indicative of serving area identifiers of current networks to which the plurality of UEs are connected.

4. The method of claim 3, wherein the selectively requesting step includes:
comparing the serving area identifier of the current network of the at least one target UE with a serving area identifier table;
determining network performance characteristics of the current network of the at least one target UE based upon the comparison;
requesting the originating UE to extend the wait timer if the network performance characteristics are indicative of high-latency; and
refraining from requesting the originating UE to extend the wait timer if the network performance characteristics are not indicative of high-latency.

5. The method of claim 3, wherein the serving area identifiers correspond to Public Land Mobile Network (PLMN) identifiers (IDs) and/or sector IDs.

6. The method of claim 1, wherein the network information indicates whether the plurality of UEs are connected to home or roaming networks, a proximity of the plurality of UEs to serving base stations within their respective networks, whether the plurality of UEs are connected to networks that support Quality of Service (QoS) and/or whether the plurality of UEs are connected to networks that are associated with high or low latencies.

7. The method of claim 1, wherein the at least one target UE corresponds to a single UE.

8. The method of claim 1, wherein the at least one target UE corresponds to multiple target UEs.

9. The method of claim 8, further comprising:
determining whether to request the originating UE to extend the wait timer based upon a weighting function applied to the network information for the multiple target UEs.

10. A method of establishing a communication session at an originating User Equipment (UE), comprising:
sending, to an application server, a request to initiate a communication session to at least one target UE;
starting a wait timer with a first expiration period, wherein expiration of the wait timer is configured to fail the originating UE's attempted initiation of the communication session; and
receiving, from the application server, a request for the originating UE to extend the wait timer from the first expiration period to a second expiration period.

11. The method of claim 10, wherein the receiving step receives the instructions in response to a determination by the application server related to network information of the at least one target UE.

12. The method of claim 11, wherein the determination by the application server is that the at least one target UE is connected to a slow response network.

13. An application server configured to establish a communication session, comprising:
means for determining network information associated with a plurality of user equipments (UEs);
means for receiving, from an originating UE, a request to initiate a communication session to at least one target UE among the plurality of UEs; and
means for selectively requesting the originating UE to extend a wait timer based at least in part upon the determined network information for the at least one target UE,
wherein expiration of the wait timer prompts the originating UE to fail the communication session.

14. An originating user equipment (UE) configured to establish a communication session, comprising:
means for sending, to an application server, a request to initiate a communication session to at least one target UE;
means for starting a wait timer with a first expiration period, wherein expiration of the wait timer is configured to fail the originating UE's attempted initiation of the communication session; and
means for receiving, from the application server, a request for the originating UE to extend the wait timer from the first expiration period to a second expiration period.

15. An application server configured to establish a communication session, comprising:
logic configured to determine network information associated with a plurality of user equipments (UEs);
logic configured to receive, from an originating UE, a request to initiate a communication session to at least one target UE among the plurality of UEs; and
logic configured to selectively request the originating UE to extend a wait timer based at least in part upon the determined network information for the at least one target UE,
wherein expiration of the wait timer prompts the originating UE to fail the communication session.

16. An originating user equipment (UE) configured to establish a communication session, comprising:
logic configured to send, to an application server, a request to initiate a communication session to at least one target UE;
logic configured to start a wait timer with a first expiration period, wherein expiration of the wait timer is configured to fail the originating UE's attempted initiation of the communication session; and
logic configured to receive, from the application server, a request for the originating UE to extend the wait timer from the first expiration period to a second expiration period.

17. A non-transitory computer-readable storage medium containing instructions stored thereon, which, when executed by an application server configured to establish a communication session, cause the application server to perform actions, the instructions comprising:
program code to determine network information associated with a plurality of user equipments (UEs);
program code to receive, from an originating UE, a request to initiate a communication session to at least one target UE among the plurality of UEs; and
program code to selectively request the originating UE to extend a wait timer based at least in part upon the determined network information for the at least one target UE,
wherein expiration of the wait timer prompts the originating UE to fail the communication session.

18. A non-transitory computer-readable storage medium containing instructions stored thereon, which, when executed by an originating user equipment (UE) configured to establish a communication session, cause the originating UE to perform actions, the instructions comprising:
program code to send, to an application server, a request to initiate a communication session to at least one target UE;
program code to start a wait timer with a first expiration period, wherein expiration of the wait timer is configured to fail the originating UE's attempted initiation of the communication session; and
program code to receive, from the application server, a request for the originating UE to extend the wait timer from the first expiration period to a second expiration period.
